(19) United States
(12) Patent Application Publication
(10) Pub. No.: US 2023/0341812 A1
(43) Pub. Date: Oct. 26, 2023

(54) MULTI-LAYERED POLARIZATION VOLUME HOLOGRAM

(71) Applicant: Facebook Technologies, LLC, Menlo Park, CA (US)

(72) Inventors: Da-Wei Lee, Kirkland, WA (US); Yun-Han Lee, Redmond, WA (US); Junren Wang, Kirkland, WA (US); Lu Lu, Kirkland, WA (US)

(21) Appl. No.: 17/727,518

(22) Filed: Apr. 22, 2022

(51) Int. Cl. G03H 1/02; G03H 1/04

(52) U.S. Cl. CPC G03H 1/0248; G03H 1/0493; G03H 1/0252; G03H 2250/38; G03H 2250/37

(57) ABSTRACT

The disclosed optical assembly may include a photoalignment layer that includes photoalignment material (PAM) anchored to a substrate according to a specified surface anchoring. The optical assembly may also include a functional or transforming layer that is applied to the photoalignment layer. The transforming layer may modify the surface anchoring of the photoalignment layer to align with a polarization volume hologram layer. The polarization volume hologram layer of the optical assembly may be disposed on the transforming layer. Various other methods of manufacturing, systems, and apparatuses are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an embodiment of an optical assembly having multiple layers.

FIG. 2 illustrates an embodiment of an optical assembly having a polarization volume grating.

FIG. 3 illustrates an embodiment of an optical assembly having a polarization volume grating and a corresponding chart showing quality levels.

FIG. 4 illustrates a microscopic view of a possible way to identify a transforming layer.

FIGS. 5A and 5B illustrate microscopic views of another possible way to identify a transforming layer.

FIGS. 6A and 6B illustrate embodiments of an optical assembly in which a transforming layer has not been applied (6A) and in which a transforming layer has been applied (6B).

FIG. 7 illustrates an embodiment of an illumination light guide having multiple gratings.

FIG. 8 is a flow diagram of an exemplary method of manufacturing an optical assembly.

FIG. 9 is a flow diagram of an alternative method of manufacturing an optical assembly.

FIG. 10 is an illustration of exemplary augmented-reality glasses that may be used in connection with embodiments of this disclosure.

FIG. 11 is an illustration of an exemplary virtual-reality headset that may be used in connection with embodiments of this disclosure.

FIG. 12 is an illustration of an exemplary system that incorporates an eye-tracking subsystem capable of tracking a user's eye(s).

FIG. 13 is a more detailed illustration of various aspects of the eye-tracking subsystem illustrated in FIG. 12.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Holograms are used in many different types of optical applications. For instance, holograms may be used in artificial reality systems as waveguide displays. In other cases, holograms may be used as combiners or lenses, or may perform other functions in an optical assembly. In some cases, these holograms may be formed using liquid crystals. For instance, polarization volume holograms (PVHs) may be formed using liquid crystals. These liquid crystals may be formed on a photo alignment material (PAM) layer. In some cases, the liquid crystals of the photoalignment layer may self-organize in a manner that is suboptimal, causing an opaque haze to occlude the PVH layer. This opaqueness may cause light to diffract differently in different parts of the PVH layer, which may lead to imperfections in holographic representations generated using the PVH layer.

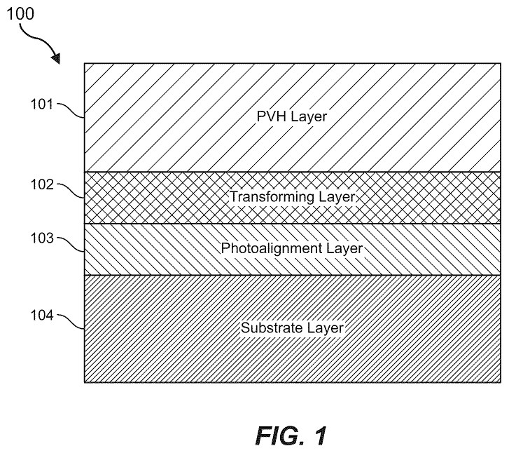

In at least some of the embodiments herein, a functional or transforming layer may be applied to the photoalignment layer to form tilted helices. Different configurations of tilted helices may be used for different PVH applications (e.g., short pitch PVH). Applying a functional or transforming layer between the PVH and the photoalignment layers may reduce or eliminate the opaqueness or haze that occurred in other systems. This transforming layer may be disposed between a photoalignment surface (e.g., a PAM surface) and a PVH layer. In some embodiments, the transforming layer may be comprised of liquid crystal and may be formed to have specific optical properties. For instance, in some cases, the transforming layer may have a birefringence (i.e., double refraction) index in a range of 0.01 to 0.5, and may have a thickness in a range of 1 nm to 100 nm. Moreover, in some embodiments, the transforming layer may be a single layer or may include multiple sub-layers, some of which may have different optical properties. These embodiments will be explained in greater detail below with regard to FIGS. 1-13.

Features from any of the embodiments described herein may be used in combination with one another in accordance with the general principles described herein. These and other embodiments, features, and advantages will be more fully understood upon reading the following detailed description in conjunction with the accompanying drawings and claims.

The present disclosure is generally directed to providing a functional or transforming layer that more reliably and more efficiently forms tilted helices on a photoalignment layer for use with polarizing volume (or other types of) holograms. As will be explained in greater detail below, embodiments of the present disclosure may manufacture or otherwise provide an optical assembly that includes a photoalignment layer having photoalignment material. This photoalignment layer may be anchored to a substrate such as glass. The surface anchoring may occur in a specified manner, and this manner may be altered by a transforming layer. Such a transforming layer may be applied to the photoalignment layer during manufacturing. When the transforming layer is applied to the photoalignment layer, the transforming layer may modify the surface anchoring of the photoalignment layer to align with a topmost polarization volume hologram layer that is, itself, applied to the transforming layer.

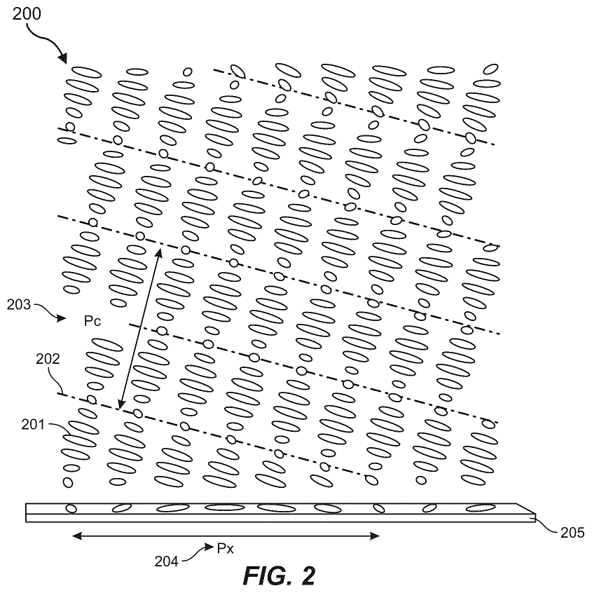

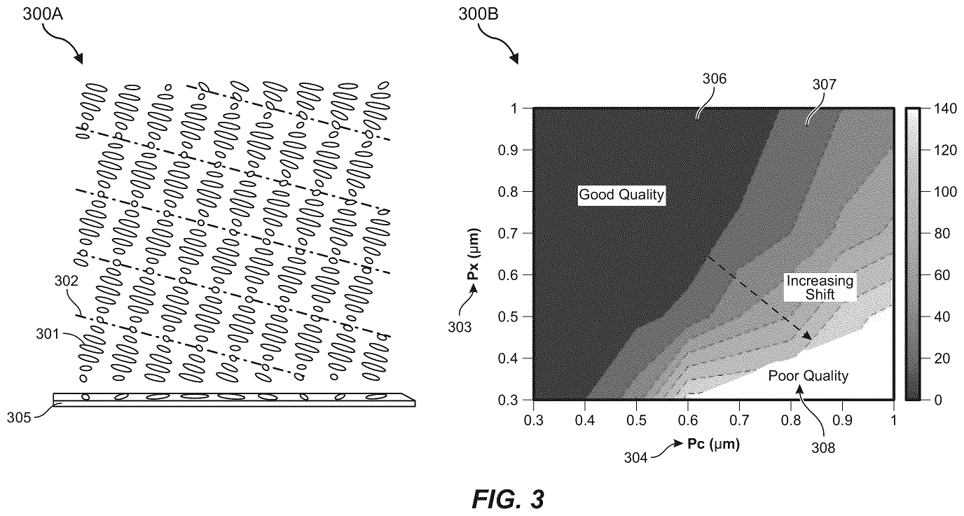

For example, as shown in embodiment 100 of FIG. 1, a transforming, functional layer may be applied between a photoalignment layer 103 and a PVH layer 101. It will be recognized herein that, while a polarization volume hologram layer is used in FIG. 1 and in many of the embodiments herein, other types of hologram layers may be implemented including different types of reflection holograms, transmission holograms, hybrid holograms, or other types of holograms. In some past cases, optical assemblies may have been created without a transforming layer, having only PVH layers, photoalignment layers, and substrate layers. In such cases, the surface anchoring of the photoalignment layer to the substrate (e.g., glass) may have resulted in a misalignment of tilted helices with respect to the PVH layer 101. In the embodiments described herein, however, a transforming layer 102 is applied to the photoalignment layer 103. This transforming layer 102 may have specific properties including a birefringence value between 0.01 and 0.5 and/or a thickness between 1 nm and 100 nm, for example. At least in some cases, these properties may have little to no effect on the optics of the photoalignment layer 103 or the PVH layer 101. Rather, the application of the transforming layer 102 may chemically alter the surface anchoring of the photoalignment layer to align more closely with the optical qualities of the PVH layer 101. This is illustrated in greater detail in FIGS. 2 and 3.

FIG. 2 illustrates an embodiment 200 of a polarization volume hologram. The PVH may include a plurality of liquid crystal (LC) molecules 201 that are spatially orientated to enable at least one optical function of the PVH layer. The LC molecules of the PVH layer may also be referred to herein as “polarization sensitive gratings,” “polarization sensitive optical elements,” or “liquid crystal gratings.” In some cases, other polarization-sensitive materials such as photopolymers may be used as an alternative to liquid crystals. Regardless of which photoalignment material is used, the liquid crystals or photopolymers may be arranged in helical configurations having specific parameters. One of these parameters may include “Pc” (203) which may indicate a Bragg period or a distance between neighboring slanted lines 202. The Bragg period (Pc) may depend on the z-axis period of the liquid crystal molecules and a slanting angle of the Bragg planes with respect to a surface of the grating 205. Another parameter may be “Px” (204), which may indicate a distance in the x-axis between liquid crystal helices 201. Different Pc and Px parameters may be used for different optical applications.

As shown in FIG. 3, however, and as noted above, when the PVH layer is bonded directly to the photoalignment layer, an increasing shift may occur, leading to opaqueness and haze in the hologram. For instance, if the liquid crystal helices 301 of embodiment 300A that result from grating 305 (tilted along diagonal line 302) are formed without a transforming functional layer (e.g., 102 of FIG. 1), then, as shown in embodiment 300B, some liquid crystals may form in a desirable manner that have positive optical qualities (e.g., 306), while other liquid crystals may form in a less desirable manner that have poor optical qualities (e.g., 308). Thus, for instance, liquid crystals with higher Px values (303) and lower Pc values (304) may result in minimal lateral shift (e.g., 306 or 307). Other liquid crystals may not form a desired surface bond to the photoalignment layer, resulting in increasing lateral shift and, as a result, poor-quality optics (e.g., liquid crystals with lower Px values 303 and higher Pc values 304 (308)). Other hologram parameters may also be affected by these sub-optimal surface bonds.

In contrast to the poor-quality regions 308 shown in FIG. 300B, the embodiments described herein may increase the amount of high-quality holographic regions, such that zones 306 and/or 307 may cover substantially the entire chart 300B. This may be accomplished through the use of a transforming layer 102 that chemically alters the surface bonds between the PVH layer (e.g., 101 of FIG. 1) and the photoalignment layer 103. Indeed, the transforming layer 102 may chemically change the surface anchoring of the photoalignment layer 103 to result in fewer liquid crystals that exhibit lateral shift (e.g., 308 of FIG. 3). In the embodiments described herein, when a hologram such as PVH is manufactured, the manufacturing process may apply a transforming layer to the photoalignment layer 103. At a molecular level, the transforming layer 102 may alter crosslinks between liquid crystal molecules, changing interactions on the photoalignment layer's surface so that the PVH layer is aligned with the photoalignment layer 103. Indeed, the transforming layer 102 may aid in the formation of the underlying photoalignment layer 103, so that the PVH layer 101 is aligned with the underlying photoalignment layer 103. This alignment between layers 101 and 103 prevents opaqueness and haze and provides a hologram that is substantially free of defects or abnormalities including lateral shift.

In some cases, as shown in FIG. 1, the PVH layer 101, the transforming layer 102, and the photoalignment layer 103 may be disposed on a structural substrate layer 104. This substrate layer may be partially or fully transparent (e.g., glass). In some cases, the substrate may be patterned to function as a grating through which a reference beam may be shone. The photoalignment layer 103 may be applied on top of the patterned portion of the substrate layer. The functional or transforming layer may modify the surface patterning of the substrate and may provide higher quality optics across many or all regions of the hologram. In some cases, the transforming layer 102 may be at least partially formed using liquid crystals. In some cases, the liquid crystals of the transforming layer have a birefringence value between 0.01 and 0.5. In other cases, the liquid crystals of the transforming layer have a birefringence value between 0.01 and 0.1, between 0.1 and 0.2, between 0.2 and 0.3, between 0.3 and 0.4, or between 0.4 and 0.5. Still further, in at least some cases, the liquid crystals of the transforming layer 102 may have a thickness between 1 nm and 100 nm. In other cases, the liquid crystals of the transforming layer 102 may have a thickness between 10 nm and 20 nm, between 20 nm and 30 nm, between 30 nm and 40 nm, between 40 nm and 50 nm, between 50 nm and 60 nm, between 60 nm and 70 nm, between 70 nm and 80 nm, between 80 nm and 90 nm, or between 90 nm and 100 nm. Thus, transforming layers with many different birefringence values and thicknesses may be used.

In some cases, the transforming layer 102 may include multiple sublayers. Each of these sublayers may include different optical characteristics including different birefringence values and different thicknesses. These sublayers may be applied to the photoalignment layer 103 in a repeating process that applies one sublayer after another onto the photoalignment layer. The liquid crystal molecules of the photoalignment layer 103 may be functionally changed or transformed by the transforming layer 102. The changes may include rotating the liquid crystal molecules into a specified pattern. This pattern may better align with the PVH layer, leading to a clearer surface that is more conducive to conducting light without introducing lateral shift.

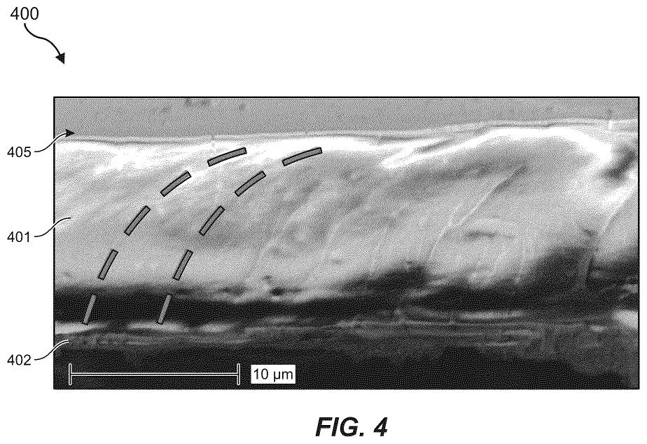

For example, image 400 of FIG. 4 illustrates an embodiment in which a transforming layer may be identified through a scanning electron microscope. When there is a boundary between different layers, for instance, layer 401 and layer 405, after removing the liquid crystal molecules by using one or more different solvents (e.g., hexane), the boundary can be identified. This boundary may indicate use of a transforming layer. The boundary may have contrasting features that define the region between layers as a boundary. The result of using a transforming layer may be a boundary such as that between layers 401 and 405, or the boundary between layers 401 and 402.

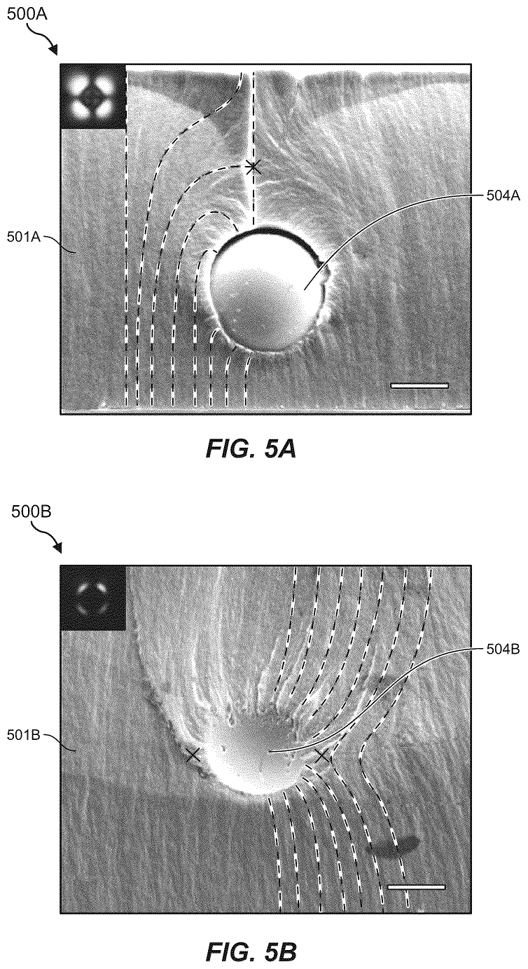

FIGS. 5A and 5B illustrate embodiments 500A and 500B that may allow users to see (through a scanning electron microscope, for example), how the liquid crystals of the photoalignment layer are formed when a transforming layer is applied during the manufacturing process. When there is a boundary between different layers, for instance, layer 501A and layer 504A, or, layer 501B and layer 504B, the boundary can be identified based on different characteristics or features in the different layers.

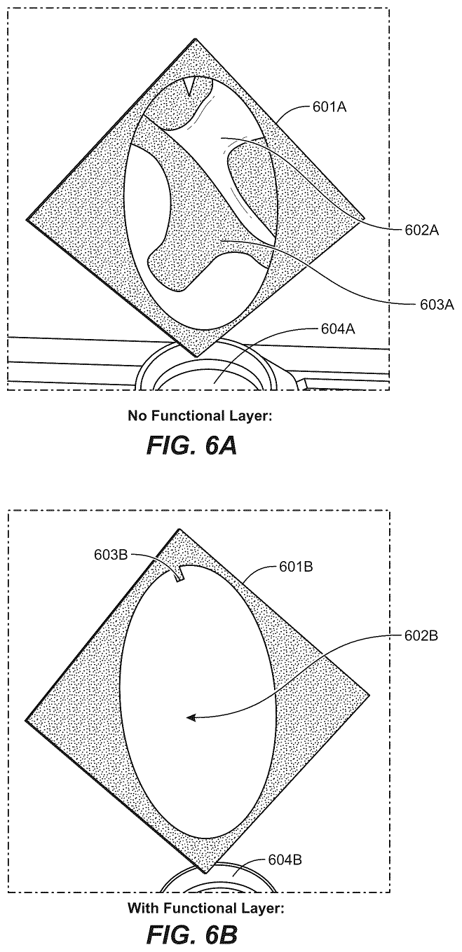

This opaqueness or haze may be more apparent in larger holograms (e.g., 3″×3″) such as those illustrated in FIGS. 6A and 6B. For instance, as shown in FIG. 6A, without the functional, transforming layer being applied, the hologram material 601A may include some portions of clear material 602A, but may also include many hazy or opaque portions 603A. These clear (602A) and opaque sections (603A) may be more visible when a light source 604A is shown onto the hologram material. In contrast, the hologram material 601B to which the functional, transforming layer has been applied may include large clear portions 602B that encompass much if not all of the available hologram material. Only relatively small portions (e.g., 603B) (or no portions at all) may be somewhat hazy or opaque when illuminated by a light source 604B. This may occur as a result of applying the transforming layer to the photoalignment layer.

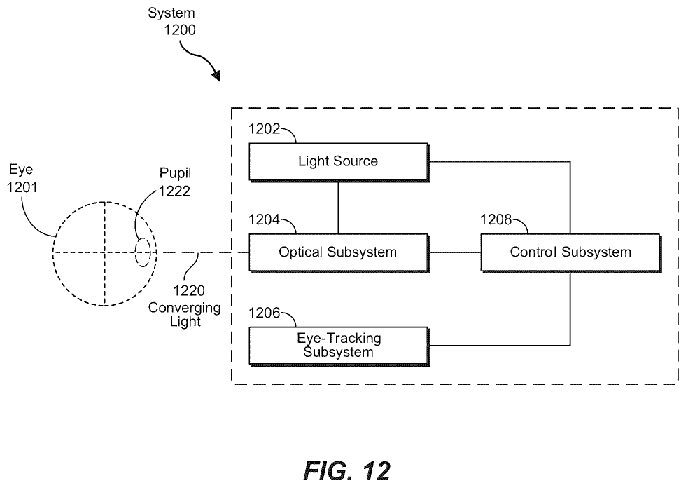

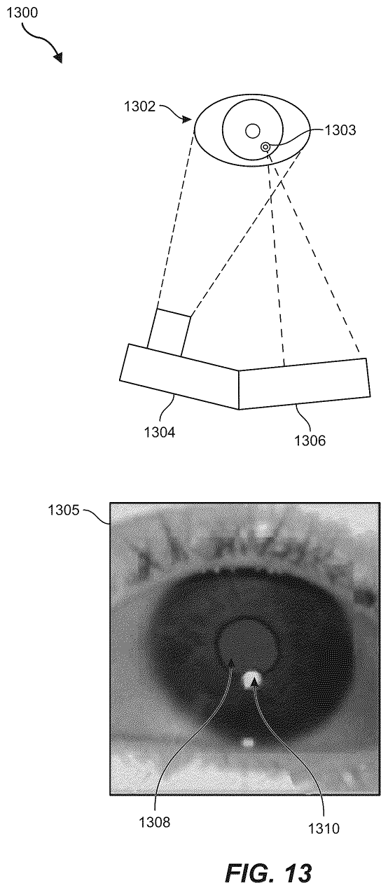

In some cases, the transforming layer 102 of FIG. 1, for example, may be implemented in different use case scenarios. For instance, the transforming layer may be applied to a photoalignment layer 103 that is then used in combination with a PVH layer 101 or some other type of holographic layer. Such an optical assembly may be used as a waveguide display, as a collimated backlight, as an eye-tracking combiner (as further explained with regard to FIGS. 12 and 13 below), as a high efficiency pancake lens, as a diffractive pancake (e.g., holo-cake) lens, or in other optical applications. At least some of these optical applications may vary the Px or Pc settings 203/204 to achieve different optical goals.

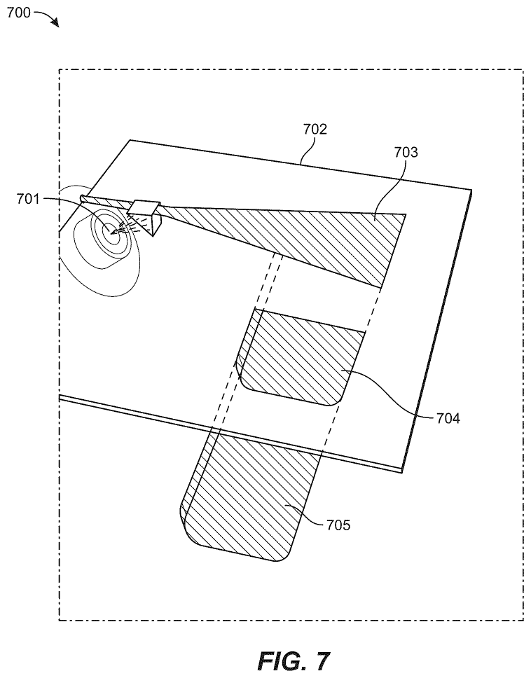

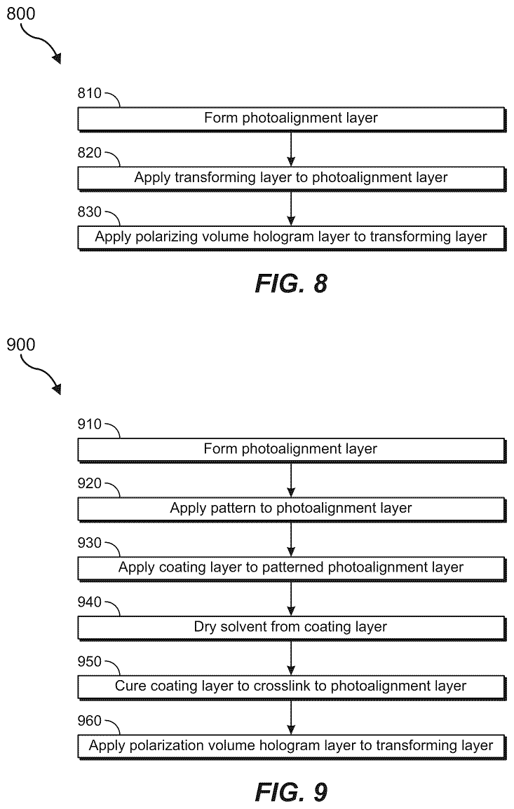

The embodiment 700 of FIG. 7 illustrates an example illumination light guide. This illumination light guide may have different gratings (e.g., fold grating 703, output grating 704) that may act in a manner similar to display waveguides. In the embodiment 700, the input light from light source 701 may be spread onto fold grating 703, and then turn to output grating 704, and then results in reflected light 705 that acts as a backlight for an LCD display. The resulting reflected light 705 may be shone onto (or may provide the backlight for) an LCD display. A transforming layer may be applied to the reflecting material 702 to align the liquid crystal (or other polymer) molecules of the photoalignment layer 103 with those of the PVH layer 101. This process of using a transforming layer to change the surface interaction of the photoalignment layer, may cause the self-organizing liquid crystals to properly form in alignment with the PVH layer. This process will be described in greater detail below with regard to methods 800 and 900 of FIGS. 8 and 9, respectively.

FIG. 8 is a flow diagram of an exemplary method 800 for manufacturing an optical assembly. The steps shown in FIG. 8 may be performed by any suitable manufacturing equipment including equipment that is controlled using computer-executable code and/or computing systems, including the systems described herein below. In one example, each of the steps shown in FIG. 8 may represent an algorithm whose structure includes and/or is represented by multiple sub-steps, examples of which will be provided in greater detail below.

As illustrated in FIG. 8, one or more of the systems described herein may manufacture, assemble, or otherwise provide an optical assembly (e.g., 100 of FIG. 1). The method of manufacturing 800 may include, at step 810, forming a photoalignment layer 103 that may include photoalignment material (PAM) anchored to a substrate in a specified manner. The method of manufacturing 800 may next include, at step 820, applying a transforming layer 102 to the photoalignment layer 103. The transforming layer 102 may modify the surface anchoring of the photoalignment layer 103 to align with a polarization volume hologram (PVH) layer 101. The PVH layer 101 may then be applied to the transforming layer 102 in step 830.

In some cases, applying the transforming layer 102 to the photoalignment layer 103 may include applying a coating layer of liquid crystal polymer to the photoalignment layer 103. Applying the transforming layer may then include curing the coating layer of liquid crystal polymer to form a solid liquid crystal film. This solid liquid crystal film may be anchored to the substrate layer 104 in a manner that aligns the liquid crystal molecules of the photoalignment layer 103 to the PVH layer 101.

In some embodiments, the coating layer of liquid crystal polymer may be cured (and, thus, harden into the solid liquid crystal film) by applying an ultraviolet light to the coating layer of liquid crystal polymer for a specified amount of time. Indeed, as shown in method of manufacturing 900 of FIG. 9, at step 910, a manufacturing device, in conjunction with a controller or processor, may form a photoalignment layer 103 using photoalignment material (e.g., liquid crystals). The method 900 may next include, at step 920, applying a pattern to the photoalignment layer 103, applying a coating layer of liquid crystal monomer to the patterned photoalignment layer at step 930, and dissolving the liquid crystal monomer in a solvent. At step 940, the method 900 may include drying the solvent from the coating layer of liquid crystal monomer and, at step 950, curing the coating layer of liquid crystal monomer to crosslink to the photoalignment layer 103 (e.g., using an ultraviolet light). The cured coating layer may thus harden to form a solid liquid crystal polymer. The PVH layer may then be applied to the coating of the photoalignment layer at step 960. Using an ultraviolet light to cure the coating layer may crosslink the liquid crystal monomer, resulting in a thin, solid polymer layer that has a surface anchoring that aligns with the PVH layer.

The resulting photoalignment layer 103 may be applied to a substrate (structural) layer 104 that is at least partially transparent. For instance, in some cases, the photoalignment layer 103 may be bonded to a substrate layer 104. As noted above, the photoalignment material (e.g., liquid crystals) may be chemically altered by the application of the transforming layer 102. The transforming layer 102 may change surface bonds to align with the optical structures of the PVH layer 101. In some cases, the liquid crystals of the transforming layer may have a birefringence index between 0.01 and 0.5. Additionally or alternatively, the liquid crystals of the transforming layer 102 may have a thickness between 10 nm and 100 nm. The transforming layer 102 may be applied in a single layer, or may be applied in a manner that results in multiple sublayers, at least some of which may have differing chemical or optical characteristics.

Accordingly, in this manner, systems, apparatuses, and methods of manufacturing may be provided for generating an optical assembly. The optical assembly may include a functional or transforming layer positioned between a PVH or other hologram layer and a photoalignment layer. The transforming layer may change how surface anchoring occurs within the photoalignment layer. Then, when the PVH layer is applied to the photoalignment layer, the liquid crystal helices may align with the PVH layer, creating a clear surface that is substantially free from haze or opaqueness and may provide little to no lateral shift across its various regions.

### Example Embodiments

Example 1: An optical assembly may include a photoalignment layer that includes photoalignment material (PAM) anchored to a substrate according to a specified surface anchoring, a transforming layer applied to the photoalignment layer, wherein the transforming layer modifies the surface anchoring of the photoalignment layer to align with a polarization volume hologram layer, and the polarization volume hologram layer disposed on the transforming layer.

Example 2: The optical assembly of Example 1, further comprising a structural layer that is at least partially transparent.

Example 3: The optical assembly of any of Examples 1 and 2, wherein the transforming layer is at least partially formed using liquid crystals.

Example 4: The computer-implemented method of any of Examples 1-3, wherein the liquid crystals of the transforming layer have a birefringence value between 0.01 and 0.5.

Example 5: The computer-implemented method of any of Examples 1-4, wherein the liquid crystals of the transforming layer have a thickness between 10 nm and 100 nm.

Example 6: The computer-implemented method of any of Examples 1-5, wherein the transforming layer includes at least one sublayer that has differing optical characteristics.

Example 7: The computer-implemented method of any of Examples 1-6, wherein the PVH layer includes a plurality of liquid crystal molecules.

Example 8: The computer-implemented method of any of Examples 1-7, wherein the liquid crystal molecules are rotated into a specified pattern.

Example 9: The computer-implemented method of any of Examples 1-8, wherein the transforming layer chemically alters the surface anchoring of the photoalignment layer.

Example 10: A method of manufacturing may include forming a photoalignment layer that includes photoalignment material (PAM) anchored to a substrate according to a specified surface anchoring, applying a transforming layer to the photoalignment layer, wherein the transforming layer modifies the surface anchoring of the photoalignment layer to align with a polarization volume hologram layer, and applying the polarization volume hologram layer to the transforming layer.

Example 11: The method of manufacturing of Example 10, wherein applying the transforming layer to the photoalignment layer may include applying a coating layer of liquid crystal polymer to the photoalignment layer and curing the coating layer of liquid crystal polymer to form a solid liquid crystal film.

Example 12: The method of manufacturing of Example 10 or Example 11, wherein the coating layer of liquid crystal polymer is cured by applying an ultraviolet light to the coating layer of liquid crystal polymer for a specified amount of time.

Example 13: The method of manufacturing of any of Examples 10-12, wherein applying the transforming layer to the photoalignment layer may include applying a pattern to the photoalignment layer, applying a coating layer of liquid crystal monomer to the patterned photoalignment layer, wherein the liquid crystal monomer is dissolved in a solvent, drying the solvent from the coating layer of liquid crystal monomer, and curing the coating layer of liquid crystal monomer to crosslink to the photoalignment layer, wherein the cured coating layer comprises a solid liquid crystal polymer.

Example 14: The method of manufacturing of any of Examples 10-13, wherein the photoalignment layer is applied to a structural layer that is at least partially transparent.

Example 15: The method of manufacturing of any of Examples 10-14, wherein the transforming layer is at least partially formed using liquid crystals.

Example 16: The method of manufacturing of any of Examples 10-15, wherein the liquid crystals of the transforming layer have a birefringence value between 0.01 and 0.5.

Example 17: The method of manufacturing of any of Examples 10-16, wherein the liquid crystals of the transforming layer have a thickness between 10 nm and 100 nm.

Example 18: The method of manufacturing of any of Examples 10-17, wherein the transforming layer includes at least one sublayer that has differing optical characteristics.

Example 19: A system may include a photoalignment layer that includes photoalignment material (PAM) anchored to a substrate according to a specified surface anchoring, a transforming layer applied to the photoalignment layer, wherein the transforming layer modifies the surface anchoring of the photoalignment layer to align with a polarization volume hologram layer and the polarization volume hologram layer disposed on the transforming layer.

Example 20: The system of Example 19, wherein the transforming layer is at least partially formed using liquid crystals, the liquid crystals of the transforming layer have a birefringence value between 0.01 and 0.5, and the liquid crystals of the transforming layer have a thickness between 10 nm and 100 nm.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

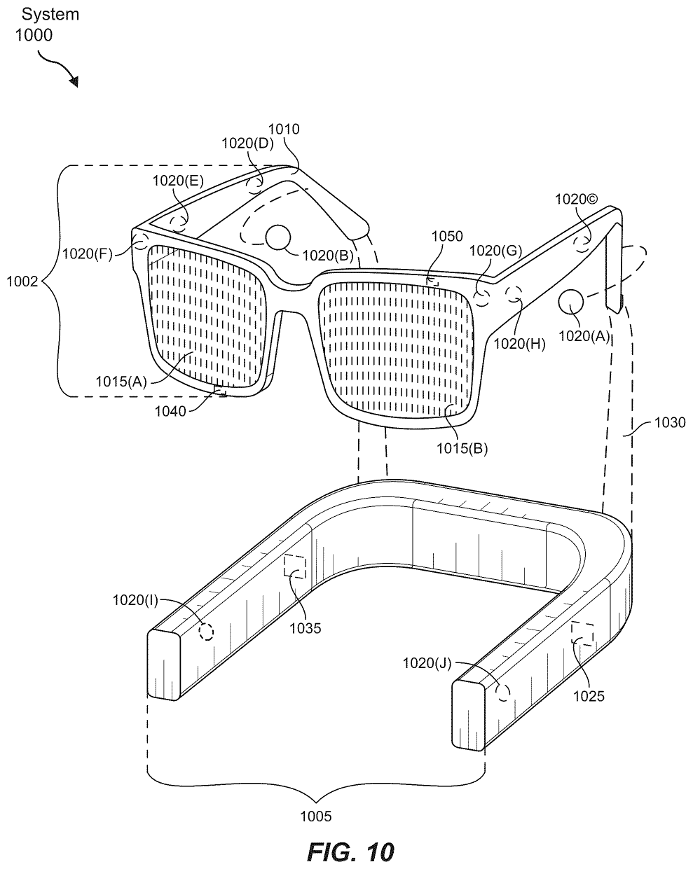

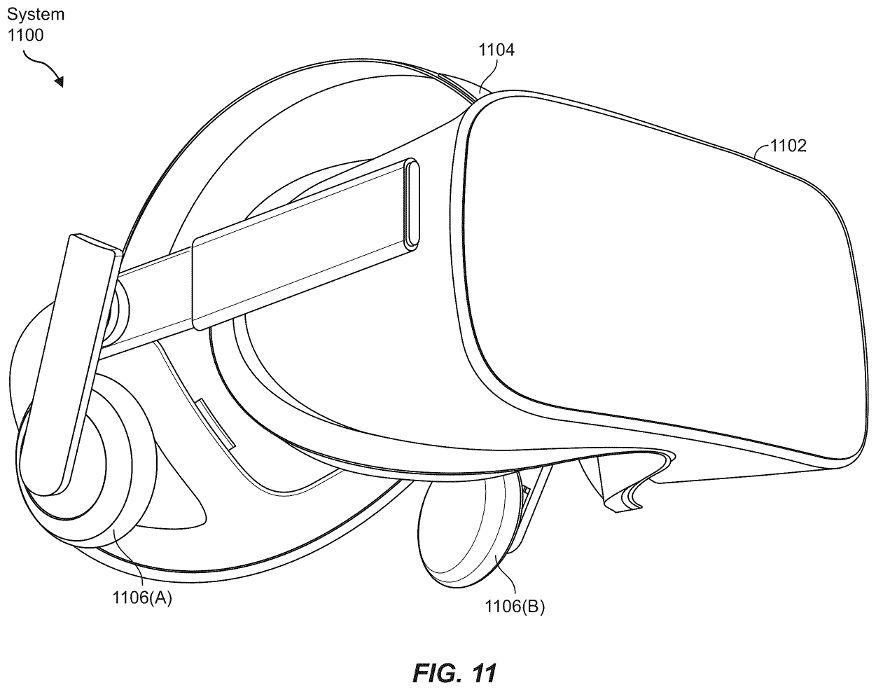

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 1000 in FIG. 10) or that visually immerses a user in an artificial reality (such as, e.g., virtual-reality system 1100 in FIG. 11). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 10, augmented-reality system 1000 may include an eyewear device 1002 with a frame 1010 configured to hold a left display device 1015(A) and a right display device 1015(B) in front of a user's eyes. Display devices 1015(A) and 1015(B) may act together or independently to present an image or series of images to a user. While augmented-reality system 1000 includes two displays, embodiments of this disclosure may be implemented in augmented-reality systems with a single NED or more than two NEDs.

In some embodiments, augmented-reality system 1000 may include one or more sensors, such as sensor 1040. Sensor 1040 may generate measurement signals in response to motion of augmented-reality system 1000 and may be located on substantially any portion of frame 1010. Sensor 1040 may represent one or more of a variety of different sensing mechanisms, such as a position sensor, an inertial measurement unit (IMU), a depth camera assembly, a structured light emitter and/or detector, or any combination thereof. In some embodiments, augmented-reality system 1000 may or may not include sensor 1040 or may include more than one sensor. In embodiments in which sensor 1040 includes an IMU, the IMU may generate calibration data based on measurement signals from sensor 1040. Examples of sensor 1040 may include, without limitation, accelerometers, gyroscopes, magnetometers, other suitable types of sensors that detect motion, sensors used for error correction of the IMU, or some combination thereof.

In some examples, augmented-reality system 1000 may also include a microphone array with a plurality of acoustic transducers 1020(A)-1020(J), referred to collectively as acoustic transducers 1020. Acoustic transducers 1020 may represent transducers that detect air pressure variations induced by sound waves. Each acoustic transducer 1020 may be configured to detect sound and convert the detected sound into an electronic format (e.g., an analog or digital format). The microphone array in FIG. 10 may include, for example, ten acoustic transducers: 1020(A) and 1020(B), which may be designed to be placed inside a corresponding ear of the user, acoustic transducers 1020(C), 1020(D), 1020(E), 1020(F), 1020(G), and 1020(H), which may be positioned at various locations on frame 1010, and/or acoustic transducers 1020(1) and 1020(J), which may be positioned on a corresponding neckband 1005.

In some embodiments, one or more of acoustic transducers 1020(A)-(J) may be used as output transducers (e.g., speakers). For example, acoustic transducers 1020(A) and/or 1020(B) may be earbuds or any other suitable type of headphone or speaker.

The configuration of acoustic transducers 1020 of the microphone array may vary. While augmented-reality system 1000 is shown in FIG. 10 as having ten acoustic transducers 1020, the number of acoustic transducers 1020 may be greater or less than ten. In some embodiments, using higher numbers of acoustic transducers 1020 may increase the amount of audio information collected and/or the sensitivity and accuracy of the audio information. In contrast, using a lower number of acoustic transducers 1020 may decrease the computing power required by an associated controller 1050 to process the collected audio information. In addition, the position of each acoustic transducer 1020 of the microphone array may vary. For example, the position of an acoustic transducer 1020 may include a defined position on the user, a defined coordinate on frame 1010, an orientation associated with each acoustic transducer 1020, or some combination thereof.

Acoustic transducers 1020(A) and 1020(B) may be positioned on different parts of the user's ear, such as behind the pinna, behind the tragus, and/or within the auricle or fossa. Or, there may be additional acoustic transducers 1020 on or surrounding the ear in addition to acoustic transducers 1020 inside the ear canal. Having an acoustic transducer 1020 positioned next to an ear canal of a user may enable the microphone array to collect information on how sounds arrive at the ear canal. By positioning at least two of acoustic transducers 1020 on either side of a user's head (e.g., as binaural microphones), augmented-reality device 1000 may simulate binaural hearing and capture a 3D stereo sound field around about a user's head. In some embodiments, acoustic transducers 1020(A) and 1020(B) may be connected to augmented-reality system 1000 via a wired connection 1030, and in other embodiments acoustic transducers 1020(A) and 1020(B) may be connected to augmented-reality system 1000 via a wireless connection (e.g., a BLUETOOTH connection). In still other embodiments, acoustic transducers 1020(A) and 1020(B) may not be used at all in conjunction with augmented-reality system 1000.

Acoustic transducers 1020 on frame 1010 may be positioned in a variety of different ways, including along the length of the temples, across the bridge, above or below display devices 1015(A) and 1015(B), or some combination thereof. Acoustic transducers 1020 may also be oriented such that the microphone array is able to detect sounds in a wide range of directions surrounding the user wearing the augmented-reality system 1000. In some embodiments, an optimization process may be performed during manufacturing of augmented-reality system 1000 to determine relative positioning of each acoustic transducer 1020 in the microphone array.

In some examples, augmented-reality system 1000 may include or be connected to an external device (e.g., a paired device), such as neckband 1005. Neckband 1005 generally represents any type or form of paired device. Thus, the following discussion of neckband 1005 may also apply to various other paired devices, such as charging cases, smart watches, smart phones, wrist bands, other wearable devices, hand-held controllers, tablet computers, laptop computers, other external compute devices, etc.

As shown, neckband 1005 may be coupled to eyewear device 1002 via one or more connectors. The connectors may be wired or wireless and may include electrical and/or non-electrical (e.g., structural) components. In some cases, eyewear device 1002 and neckband 1005 may operate independently without any wired or wireless connection between them. While FIG. 10 illustrates the components of eyewear device 1002 and neckband 1005 in example locations on eyewear device 1002 and neckband 1005, the components may be located elsewhere and/or distributed differently on eyewear device 1002 and/or neckband 1005. In some embodiments, the components of eyewear device 1002 and neckband 1005 may be located on one or more additional peripheral devices paired with eyewear device 1002, neckband 1005, or some combination thereof.

Pairing external devices, such as neckband 1005, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 1000 may be provided by a paired device or shared between a paired device and an eyewear device, thus reducing the weight, heat profile, and form factor of the eyewear device overall while still retaining desired functionality. For example, neckband 1005 may allow components that would otherwise be included on an eyewear device to be included in neckband 1005 since users may tolerate a heavier weight load on their shoulders than they would tolerate on their heads. Neckband 1005 may also have a larger surface area over which to diffuse and disperse heat to the ambient environment. Thus, neckband 1005 may allow for greater battery and computation capacity than might otherwise have been possible on a stand-alone eyewear device. Since weight carried in neckband 1005 may be less invasive to a user than weight carried in eyewear device 1002, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 1005 may be communicatively coupled with eyewear device 1002 and/or to other devices. These other devices may provide certain functions (e.g., tracking, localizing, depth mapping, processing, storage, etc.) to augmented-reality system 1000. In the embodiment of FIG. 10, neckband 1005 may include two acoustic transducers (e.g., 1020(1) and 1020(J)) that are part of the microphone array (or potentially form their own microphone subarray). Neckband 1005 may also include a controller 1025 and a power source 1035.

Acoustic transducers 1020(1) and 1020(J) of neckband 1005 may be configured to detect sound and convert the detected sound into an electronic format (analog or digital). In the embodiment of FIG. 10, acoustic transducers 1020(1) and 1020(J) may be positioned on neckband 1005, thereby increasing the distance between the neckband acoustic transducers 1020(1) and 1020(J) and other acoustic transducers 1020 positioned on eyewear device 1002. In some cases, increasing the distance between acoustic transducers 1020 of the microphone array may improve the accuracy of beamforming performed via the microphone array. For example, if a sound is detected by acoustic transducers 1020(C) and 1020(D) and the distance between acoustic transducers 1020(C) and 1020(D) is greater than, e.g., the distance between acoustic transducers 1020(D) and 1020(E), the determined source location of the detected sound may be more accurate than if the sound had been detected by acoustic transducers 1020(D) and 1020(E).

Controller 1025 of neckband 1005 may process information generated by the sensors on neckband 1005 and/or augmented-reality system 1000. For example, controller 1025 may process information from the microphone array that describes sounds detected by the microphone array. For each detected sound, controller 1025 may perform a direction-of-arrival (DOA) estimation to estimate a direction from which the detected sound arrived at the microphone array. As the microphone array detects sounds, controller 1025 may populate an audio data set with the information. In embodiments in which augmented-reality system 1000 includes an inertial measurement unit, controller 1025 may compute all inertial and spatial calculations from the IMU located on eyewear device 1002. A connector may convey information between augmented-reality system 1000 and neckband 1005 and between augmented-reality system 1000 and controller 1025. The information may be in the form of optical data, electrical data, wireless data, or any other transmittable data form. Moving the processing of information generated by augmented-reality system 1000 to neckband 1005 may reduce weight and heat in eyewear device 1002, making it more comfortable to the user.

Power source 1035 in neckband 1005 may provide power to eyewear device 1002 and/or to neckband 1005. Power source 1035 may include, without limitation, lithium ion batteries, lithium-polymer batteries, primary lithium batteries, alkaline batteries, or any other form of power storage. In some cases, power source 1035 may be a wired power source. Including power source 1035 on neckband 1005 instead of on eyewear device 1002 may help better distribute the weight and heat generated by power source 1035.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1100 in FIG. 11, that mostly or completely covers a user's field of view. Virtual-reality system 1100 may include a front rigid body 1102 and a band 1104 shaped to fit around a user's head. Virtual-reality system 1100 may also include output audio transducers 1106(A) and 1106(B). Furthermore, while not shown in FIG. 11, front rigid body 1102 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 1000 and/or virtual-reality system 1100 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 1000 and/or virtual-reality system 1100 may include microLED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 1000 and/or virtual-reality system 1100 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In some embodiments, the systems described herein may also include an eye-tracking subsystem designed to identify and track various characteristics of a user's eye(s), such as the user's gaze direction. The phrase “eye tracking” may, in some examples, refer to a process by which the position, orientation, and/or motion of an eye is measured, detected, sensed, determined, and/or monitored. The disclosed systems may measure the position, orientation, and/or motion of an eye in a variety of different ways, including through the use of various optical-based eye-tracking techniques, ultrasound-based eye-tracking techniques, etc. An eye-tracking subsystem may be configured in a number of different ways and may include a variety of different eye-tracking hardware components or other computer-vision components. For example, an eye-tracking subsystem may include a variety of different optical sensors, such as two-dimensional (2D) or 3D cameras, time-of-flight depth sensors, single-beam or sweeping laser rangefinders, 3D LiDAR sensors, and/or any other suitable type or form of optical sensor. In this example, a processing subsystem may process data from one or more of these sensors to measure, detect, determine, and/or otherwise monitor the position, orientation, and/or motion of the user's eye(s).

FIG. 12 is an illustration of an exemplary system 1200 that incorporates an eye-tracking subsystem capable of tracking a user's eye(s). As depicted in FIG. 12, system 1200 may include a light source 1202, an optical subsystem 1204, an eye-tracking subsystem 1206, and/or a control subsystem 1208. In some examples, light source 1202 may generate light for an image (e.g., to be presented to an eye 1201 of the viewer). Light source 1202 may represent any of a variety of suitable devices. For example, light source 1202 can include a two-dimensional projector (e.g., a LCoS display), a scanning source (e.g., a scanning laser), or other device (e.g., an LCD, an LED display, an OLED display, an active-matrix OLED display (AMOLED), a transparent OLED display (TOLED), a waveguide, or some other display capable of generating light for presenting an image to the viewer). In some examples, the image may represent a virtual image, which may refer to an optical image formed from the apparent divergence of light rays from a point in space, as opposed to an image formed from the light ray's actual divergence.

In some embodiments, optical subsystem 1204 may receive the light generated by light source 1202 and generate, based on the received light, converging light 1220 that includes the image. In some examples, optical subsystem 1204 may include any number of lenses (e.g., Fresnel lenses, convex lenses, concave lenses), apertures, filters, mirrors, prisms, and/or other optical components, possibly in combination with actuators and/or other devices. In particular, the actuators and/or other devices may translate and/or rotate one or more of the optical components to alter one or more aspects of converging light 1220. Further, various mechanical couplings may serve to maintain the relative spacing and/or the orientation of the optical components in any suitable combination.

In one embodiment, eye-tracking subsystem 1206 may generate tracking information indicating a gaze angle of an eye 1201 of the viewer. In this embodiment, control subsystem 1208 may control aspects of optical subsystem 1204 (e.g., the angle of incidence of converging light 1220) based at least in part on this tracking information. Additionally, in some examples, control subsystem 1208 may store and utilize historical tracking information (e.g., a history of the tracking information over a given duration, such as the previous second or fraction thereof) to anticipate the gaze angle of eye 1201 (e.g., an angle between the visual axis and the anatomical axis of eye 1201). In some embodiments, eye-tracking subsystem 1206 may detect radiation emanating from some portion of eye 1201 (e.g., the cornea, the iris, the pupil, or the like) to determine the current gaze angle of eye 1201. In other examples, eye-tracking subsystem 1206 may employ a wavefront sensor to track the current location of the pupil.

Any number of techniques can be used to track eye 1201. Some techniques may involve illuminating eye 1201 with infrared light and measuring reflections with at least one optical sensor that is tuned to be sensitive to the infrared light. Information about how the infrared light is reflected from eye 1201 may be analyzed to determine the position(s), orientation(s), and/or motion(s) of one or more eye feature(s), such as the cornea, pupil, iris, and/or retinal blood vessels.

In some examples, the radiation captured by a sensor of eye-tracking subsystem 1206 may be digitized (i.e., converted to an electronic signal). Further, the sensor may transmit a digital representation of this electronic signal to one or more processors (for example, processors associated with a device including eye-tracking subsystem 1206). Eye-tracking subsystem 1206 may include any of a variety of sensors in a variety of different configurations. For example, eye-tracking subsystem 1206 may include an infrared detector that reacts to infrared radiation. The infrared detector may be a thermal detector, a photonic detector, and/or any other suitable type of detector. Thermal detectors may include detectors that react to thermal effects of the incident infrared radiation.

In some examples, one or more processors may process the digital representation generated by the sensor(s) of eye-tracking subsystem 1206 to track the movement of eye 1201. In another example, these processors may track the movements of eye 1201 by executing algorithms represented by computer-executable instructions stored on non-transitory memory. In some examples, on-chip logic (e.g., an application-specific integrated circuit or ASIC) may be used to perform at least portions of such algorithms. As noted, eye-tracking subsystem 1206 may be programmed to use an output of the sensor(s) to track movement of eye 1201. In some embodiments, eye-tracking subsystem 1206 may analyze the digital representation generated by the sensors to extract eye rotation information from changes in reflections. In one embodiment, eye-tracking subsystem 1206 may use corneal reflections or glints (also known as Purkinje images) and/or the center of the eye's pupil 1222 as features to track over time.

In some embodiments, eye-tracking subsystem 1206 may use the center of the eye's pupil 1222 and infrared or near-infrared, non-collimated light to create corneal reflections. In these embodiments, eye-tracking subsystem 1206 may use the vector between the center of the eye's pupil 1222 and the corneal reflections to compute the gaze direction of eye 1201. In some embodiments, the disclosed systems may perform a calibration procedure for an individual (using, e.g., supervised or unsupervised techniques) before tracking the user's eyes. For example, the calibration procedure may include directing users to look at one or more points displayed on a display while the eye-tracking system records the values that correspond to each gaze position associated with each point.

In some embodiments, eye-tracking subsystem 1206 may use two types of infrared and/or near-infrared (also known as active light) eye-tracking techniques: bright-pupil and dark-pupil eye tracking, which may be differentiated based on the location of an illumination source with respect to the optical elements used. If the illumination is coaxial with the optical path, then eye 1201 may act as a retroreflector as the light reflects off the retina, thereby creating a bright pupil effect similar to a red-eye effect in photography. If the illumination source is offset from the optical path, then the eye's pupil 1222 may appear dark because the retroreflection from the retina is directed away from the sensor. In some embodiments, bright-pupil tracking may create greater iris/pupil contrast, allowing more robust eye tracking with iris pigmentation, and may feature reduced interference (e.g., interference caused by eyelashes and other obscuring features). Bright-pupil tracking may also allow tracking in lighting conditions ranging from total darkness to a very bright environment.

In some embodiments, control subsystem 1208 may control light source 1202 and/or optical subsystem 1204 to reduce optical aberrations (e.g., chromatic aberrations and/or monochromatic aberrations) of the image that may be caused by or influenced by eye 1201. In some examples, as mentioned above, control subsystem 1208 may use the tracking information from eye-tracking subsystem 1206 to perform such control. For example, in controlling light source 1202, control subsystem 1208 may alter the light generated by light source 1202 (e.g., by way of image rendering) to modify (e.g., pre-distort) the image so that the aberration of the image caused by eye 1201 is reduced.

The disclosed systems may track both the position and relative size of the pupil (since, e.g., the pupil dilates and/or contracts). In some examples, the eye-tracking devices and components (e.g., sensors and/or sources) used for detecting and/or tracking the pupil may be different (or calibrated differently) for different types of eyes. For example, the frequency range of the sensors may be different (or separately calibrated) for eyes of different colors and/or different pupil types, sizes, and/or the like. As such, the various eye-tracking components (e.g., infrared sources and/or sensors) described herein may need to be calibrated for each individual user and/or eye.

The disclosed systems may track both eyes with and without ophthalmic correction, such as that provided by contact lenses worn by the user. In some embodiments, ophthalmic correction elements (e.g., adjustable lenses) may be directly incorporated into the artificial reality systems described herein. In some examples, the color of the user's eye may necessitate modification of a corresponding eye-tracking algorithm. For example, eye-tracking algorithms may need to be modified based at least in part on the differing color contrast between a brown eye and, for example, a blue eye.

FIG. 13 is a more detailed illustration of various aspects of the eye-tracking subsystem illustrated in FIG. 12. As shown in this figure, an eye-tracking subsystem 1300 may include at least one source 1304 and at least one sensor 1306. Source 1304 generally represents any type or form of element capable of emitting radiation. In one example, source 1304 may generate visible, infrared, and/or near-infrared radiation. In some examples, source 1304 may radiate non-collimated infrared and/or near-infrared portions of the electromagnetic spectrum towards an eye 1302 of a user. Source 1304 may utilize a variety of sampling rates and speeds. For example, the disclosed systems may use sources with higher sampling rates in order to capture fixational eye movements of a user's eye 1302 and/or to correctly measure saccade dynamics of the user's eye 1302. As noted above, any type or form of eye-tracking technique may be used to track the user's eye 1302, including optical-based eye-tracking techniques, ultrasound-based eye-tracking techniques, etc.

Sensor 1306 generally represents any type or form of element capable of detecting radiation, such as radiation reflected off the user's eye 1302. Examples of sensor 1306 include, without limitation, a charge coupled device (CCD), a photodiode array, a complementary metal-oxide-semiconductor (CMOS) based sensor device, and/or the like. In one example, sensor 1306 may represent a sensor having predetermined parameters, including, but not limited to, a dynamic resolution range, linearity, and/or other characteristic selected and/or designed specifically for eye tracking.

As detailed above, eye-tracking subsystem 1300 may generate one or more glints. As detailed above, a glint 1303 may represent reflections of radiation (e.g., infrared radiation from an infrared source, such as source 1304) from the structure of the user's eye. In various embodiments, glint 1303 and/or the user's pupil may be tracked using an eye-tracking algorithm executed by a processor (either within or external to an artificial reality device). For example, an artificial reality device may include a processor and/or a memory device in order to perform eye tracking locally and/or a transceiver to send and receive the data necessary to perform eye tracking on an external device (e.g., a mobile phone, cloud server, or other computing device).

FIG. 13 shows an example image 1305 captured by an eye-tracking subsystem, such as eye-tracking subsystem 1300. In this example, image 1305 may include both the user's pupil 1308 and a glint 1310 near the same. In some examples, pupil 1308 and/or glint 1310 may be identified using an artificial-intelligence-based algorithm, such as a computer-vision-based algorithm. In one embodiment, image 1305 may represent a single frame in a series of frames that may be analyzed continuously in order to track the eye 1302 of the user. Further, pupil 1308 and/or glint 1310 may be tracked over a period of time to determine a user's gaze.

In one example, eye-tracking subsystem 1300 may be configured to identify and measure the inter-pupillary distance (IPD) of a user. In some embodiments, eye-tracking subsystem 1300 may measure and/or calculate the IPD of the user while the user is wearing the artificial reality system. In these embodiments, eye-tracking subsystem 1300 may detect the positions of a user's eyes and may use this information to calculate the user's IPD.

As noted, the eye-tracking systems or subsystems disclosed herein may track a user's eye position and/or eye movement in a variety of ways. In one example, one or more light sources and/or optical sensors may capture an image of the user's eyes. The eye-tracking subsystem may then use the captured information to determine the user's inter-pupillary distance, interocular distance, and/or a 3D position of each eye (e.g., for distortion adjustment purposes), including a magnitude of torsion and rotation (i.e., roll, pitch, and yaw) and/or gaze directions for each eye. In one example, infrared light may be emitted by the eye-tracking subsystem and reflected from each eye. The reflected light may be received or detected by an optical sensor and analyzed to extract eye rotation data from changes in the infrared light reflected by each eye.

The eye-tracking subsystem may use any of a variety of different methods to track the eyes of a user. For example, a light source (e.g., infrared light-emitting diodes) may emit a dot pattern onto each eye of the user. The eye-tracking subsystem may then detect (e.g., via an optical sensor coupled to the artificial reality system) and analyze a reflection of the dot pattern from each eye of the user to identify a location of each pupil of the user. Accordingly, the eye-tracking subsystem may track up to six degrees of freedom of each eye (i.e., 3D position, roll, pitch, and yaw) and at least a subset of the tracked quantities may be combined from two eyes of a user to estimate a gaze point (i.e., a 3D location or position in a virtual scene where the user is looking) and/or an IPD.

In some cases, the distance between a user's pupil and a display may change as the user's eye moves to look in different directions. The varying distance between a pupil and a display as viewing direction changes may be referred to as “pupil swim” and may contribute to distortion perceived by the user as a result of light focusing in different locations as the distance between the pupil and the display changes. Accordingly, measuring distortion at different eye positions and pupil distances relative to displays and generating distortion corrections for different positions and distances may allow mitigation of distortion caused by pupil swim by tracking the 3D position of a user's eyes and applying a distortion correction corresponding to the 3D position of each of the user's eyes at a given point in time. Thus, knowing the 3D position of each of a user's eyes may allow for the mitigation of distortion caused by changes in the distance between the pupil of the eye and the display by applying a distortion correction for each 3D eye position. Furthermore, as noted above, knowing the position of each of the user's eyes may also enable the eye-tracking subsystem to make automated adjustments for a user's IPD.

In some embodiments, a display subsystem may include a variety of additional subsystems that may work in conjunction with the eye-tracking subsystems described herein. For example, a display subsystem may include a varifocal subsystem, a scene-rendering module, and/or a vergence-processing module. The varifocal subsystem may cause left and right display elements to vary the focal distance of the display device. In one embodiment, the varifocal subsystem may physically change the distance between a display and the optics through which it is viewed by moving the display, the optics, or both. Additionally, moving or translating two lenses relative to each other may also be used to change the focal distance of the display. Thus, the varifocal subsystem may include actuators or motors that move displays and/or optics to change the distance between them. This varifocal subsystem may be separate from or integrated into the display subsystem. The varifocal subsystem may also be integrated into or separate from its actuation subsystem and/or the eye-tracking subsystems described herein.

In one example, the display subsystem may include a vergence-processing module configured to determine a vergence depth of a user's gaze based on a gaze point and/or an estimated intersection of the gaze lines determined by the eye-tracking subsystem. Vergence may refer to the simultaneous movement or rotation of both eyes in opposite directions to maintain single binocular vision, which may be naturally and automatically performed by the human eye. Thus, a location where a user's eyes are verged is where the user is looking and is also typically the location where the user's eyes are focused. For example, the vergence-processing module may triangulate gaze lines to estimate a distance or depth from the user associated with intersection of the gaze lines. The depth associated with intersection of the gaze lines may then be used as an approximation for the accommodation distance, which may identify a distance from the user where the user's eyes are directed. Thus, the vergence distance may allow for the determination of a location where the user's eyes should be focused and a depth from the user's eyes at which the eyes are focused, thereby providing information (such as an object or plane of focus) for rendering adjustments to the virtual scene.

The vergence-processing module may coordinate with the eye-tracking subsystems described herein to make adjustments to the display subsystem to account for a user's vergence depth. When the user is focused on something at a distance, the user's pupils may be slightly farther apart than when the user is focused on something close. The eye-tracking subsystem may obtain information about the user's vergence or focus depth and may adjust the display subsystem to be closer together when the user's eyes focus or verge on something close and to be farther apart when the user's eyes focus or verge on something at a distance.

The eye-tracking information generated by the above-described eye-tracking subsystems may also be used, for example, to modify various aspect of how different computer-generated images are presented. For example, a display subsystem may be configured to modify, based on information generated by an eye-tracking subsystem, at least one aspect of how the computer-generated images are presented. For instance, the computer-generated images may be modified based on the user's eye movement, such that if a user is looking up, the computer-generated images may be moved upward on the screen. Similarly, if the user is looking to the side or down, the computer-generated images may be moved to the side or downward on the screen. If the user's eyes are closed, the computer-generated images may be paused or removed from the display and resumed once the user's eyes are back open.

The above-described eye-tracking subsystems can be incorporated into one or more of the various artificial reality systems described herein in a variety of ways. For example, one or more of the various components of system 1200 and/or eye-tracking subsystem 1300 may be incorporated into augmented-reality system 1000 in FIG. 10 and/or virtual-reality system 1100 in FIG. 11 to enable these systems to perform various eye-tracking tasks (including one or more of the eye-tracking operations described herein).

As detailed above, the computing devices and systems described and/or illustrated herein, including computing systems used to control manufacturing processes and/or, more specifically, the methods of manufacturing described herein, broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An optical assembly comprising:
a photoalignment layer that includes photoalignment material (PAM) anchored to a substrate according to a specified surface anchoring;
a transforming layer applied to the photoalignment layer, wherein the transforming layer modifies the surface anchoring of the photoalignment layer to align with a polarization volume hologram layer; and
the polarization volume hologram layer disposed on the transforming layer.

2. The optical assembly of claim 1, further comprising a structural layer that is at least partially transparent.

3. The optical assembly of claim 1, wherein the transforming layer is at least partially formed using liquid crystals.

4. The optical assembly of claim 3, wherein the liquid crystals of the transforming layer have a birefringence value between 0.01 and 0.5.

5. The optical assembly of claim 3, wherein the liquid crystals of the transforming layer have a thickness between 1 nm and 100 nm.

6. The optical assembly of claim 1, wherein the transforming layer includes at least one sublayer that has differing optical characteristics.

7. The optical assembly of claim 1, wherein the polarization volume hologram layer includes a plurality of liquid crystal molecules.

8. The optical assembly of claim 7, wherein the liquid crystal molecules are rotated into a specified pattern.

9. The optical assembly of claim 1, wherein the transforming layer chemically alters the surface anchoring of the photoalignment layer.

10. A method of manufacturing comprising:
forming a photoalignment layer that includes photoalignment material (PAM) anchored to a substrate according to a specified surface anchoring;
applying a transforming layer to the photoalignment layer, wherein the transforming layer modifies the surface anchoring of the photoalignment layer to align with a polarization volume hologram layer; and
applying the polarization volume hologram layer to the transforming layer.

11. The method of manufacturing of claim 10, wherein applying the transforming layer to the photoalignment layer includes:
applying a coating layer of liquid crystal polymer to the photoalignment layer; and
curing the coating layer of liquid crystal polymer to form a liquid crystal film.

12. The method of manufacturing of claim 11, wherein the coating layer of liquid crystal polymer is cured by applying an ultraviolet light to the coating layer of liquid crystal polymer for a specified amount of time.

13. The method of manufacturing of claim 12, wherein applying the transforming layer to the photoalignment layer includes:
applying a pattern to the photoalignment layer;
applying a coating layer of liquid crystal monomer to the patterned photoalignment layer, wherein the liquid crystal monomer is dissolved in a solvent;
drying the solvent from the coating layer of liquid crystal monomer; and
curing the coating layer of liquid crystal monomer to crosslink to the photoalignment layer, wherein the cured coating layer comprises a solid liquid crystal polymer.

14. The method of manufacturing of claim 10, wherein the photoalignment layer is applied to a structural layer that is at least partially transparent.

15. The method of manufacturing of claim 10, wherein the transforming layer is at least partially formed using liquid crystals.

16. The method of manufacturing of claim 15, wherein the liquid crystals of the transforming layer have a birefringence value between 0.01 and 0.5.

17. The method of manufacturing of claim 15, wherein the liquid crystals of the transforming layer have a thickness between 10 nm and 100 nm.

18. The method of manufacturing of claim 10, wherein the transforming layer includes at least one sublayer that has differing optical characteristics.

19. A system comprising:
a photoalignment layer that includes photoalignment material (PAM) anchored to a substrate according to a specified surface anchoring;
a transforming layer applied to the photoalignment layer, wherein the transforming layer modifies the surface anchoring of the photoalignment layer to align with a polarization volume hologram layer; and
the polarization volume hologram layer disposed on the transforming layer.

20. The system of claim 19, wherein:
the transforming layer is at least partially formed using liquid crystals,
the liquid crystals of the transforming layer have a birefringence value between 0.01 and 0.5, and
the liquid crystals of the transforming layer have a thickness between 1 nm and 100 nm.
